(19) United States
(12) Patent Application Publication
(10) Pub. No.: US 2002/0088346 A1
(43) Pub. Date: Jul. 11, 2002

(54) Filtering mass in sheet form for an air filter for an enclosed space, particularly for a motor vehicle cabin, and methods for a motor vehicle cabin, and methods for obtaining the mass

(75) Inventors: Paolo Baracchi, Torino (IT); Claudio Crovetti, Mantova (IT); Sergio Tallano, Porto Mantovano (IT)

Correspondence Address: MODIANO & ASSOCIATI, Via Meravigli, 16, MILANO, 20123, IT

(73) Assignee: SOGEFI FILTRATION S.p.A.

(21) Appl. No.: 10/086,560

(22) Filed: Mar. 4, 2002

(30) Foreign Application Priority Data
Dec. 12, 2000 (IT) MI2000A002682

(51) Int. Cl. B01D 53/02

(52) U.S. Cl. 96/134; 96/154; 55/486; 55/527

(57) ABSTRACT

A filtering mass in sheet form for an air filter for an enclosed space, particularly a motor vehicle cabin, comprising elements made of standard-type materials normally used to form filtering masses and carbon elements rendered active in the adsorption of gaseous substances.

### BACKGROUND OF THE INVENTION

The present invention relates to a filtering mass in sheet form for an air filter for an enclosed space, particularly for a motor vehicle cabin, and to methods for obtaining such mass.

Filters are known which are installed at ventilation systems of enclosed spaces in order to filter the external air that enters the enclosed spaces; this is the case, for example, of motor vehicle cabins, or of buildings used for living or for work.

Very commonly, such filters comprise a filtering mass in sheet form, which is inserted in a pleated or flat arrangement in a supporting frame, and currently the filtering mass is substantially produced according to two types.

A first type of filtering mass consists of a sheet formed by fibers of different materials, such as for example polyester, polyamide, polypropylene, pure or mixed together, providing what is known as “non-woven fabric”, or also by cellulose fibers, either substantially pure or mixed with fibers of materials such as the ones cited above, providing what is known as “filter paper”.

The materials and fibers currently used are referenced respectively hereinafter as “standard-type materials” and “standard fibers”.

The fiber mat meant to constitute the sheet of filtering mass is subjected, after forming, to impregnation in order to give it the necessary mechanical consistency and any other characteristics, such as for example fire-resistant and antibacterial properties, and is finally subjected to finishing operations.

With this type of filtering mass, filters are produced which are known as “particulate filters” because they are capable of retaining exclusively particulate matter.

If it is also necessary to retain unwanted gaseous substances, a second type of sheet of filtering mass is currently used which is constituted by an intermediate layer of carbon granules enclosed between two layers of standard fibers, which ensure particle retention, while the intermediate layer of carbon granules retains the gaseous substances.

This second type of sheet of filtering mass, however, has drawbacks, such as a high cost and the generation of high load losses; moreover, carbon granules can break away and be dispersed into the environment.

### SUMMARY OF THE INVENTION

The aim of the present invention is to provide a filtering mass in sheet form for an air filter, which is capable of retaining both particulate matter and undesirable gaseous substances, has a low cost, generates limited load losses and cannot cause contamination.

This aim is achieved by a filtering mass in sheet form for an air filter for an enclosed space, particularly a motor vehicle cabin, according to the invention, characterized in that it comprises elements made of standard-type materials normally used to form filtering masses and carbon elements rendered active for the adsorption of gaseous substances.

### BRIEF DESCRIPTION OF THE DRAWINGS

Further characteristics and advantages of the invention will become better apparent from the description of some preferred but not exclusive embodiments thereof, illustrated only by way of non-limitative example in the accompanying drawings, wherein:

FIG. 1 is a view of a portion of a sheet of filtering mass with a single layer of elements in fiber form;

FIGS. 2 to 5 are views of portions of different sheets of filtering mass with two layers of elements in fiber form;

FIG. 6 is a view of a portion of a sheet of filtering mass with a single layer of fabric formed by elements in filament form;

FIG. 7 is a view of a portion of a sheet of filtering mass with a layer of fabric formed by elements in filament form and a layer of elements in fiber form;

FIG. 8 is a view of a portion of a sheet of filtering mass with three layers of elements in fiber form.

### DESCRIPTION OF THE PREFERRED EMBODIMENTS

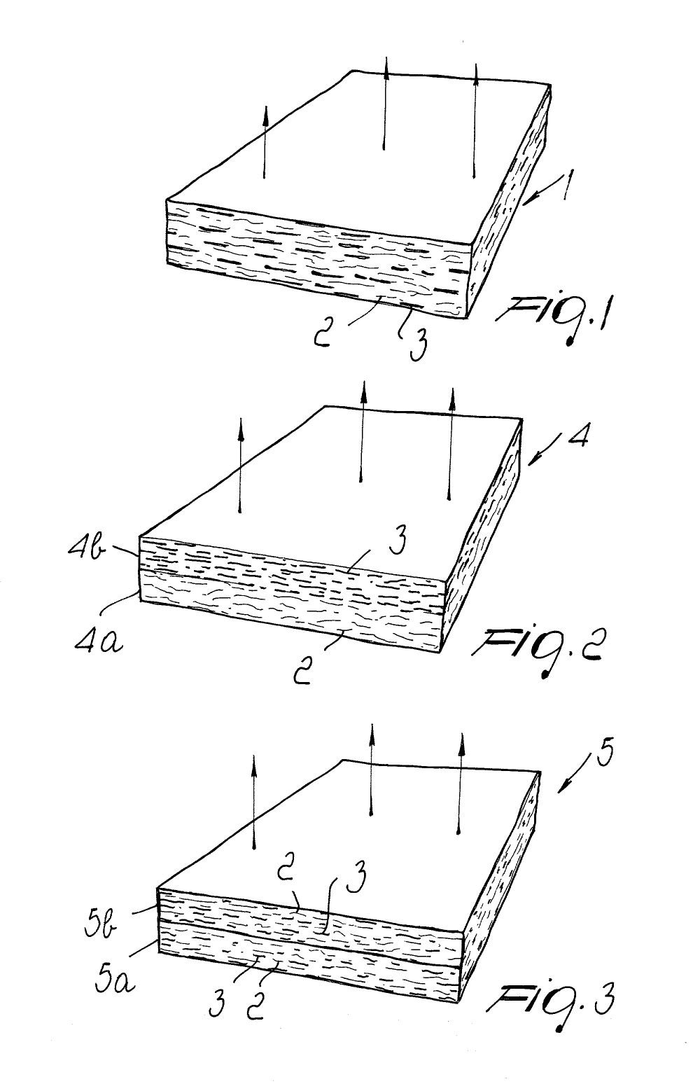

With reference to FIG. 1, the reference numeral 1 designates a portion of a sheet of filtering mass which comprises a single layer of elements in the form of fibers of materials normally used in the manufacture of filters which, as mentioned, are referenced herein as standard fibers, are shown in thin lines and are designated by the reference numeral 2; these fibers are mixed with carbon fibers, shown in thick lines and designated by the reference numeral 3, which are generally obtained from vegetable or synthetic polymers, activated for the adsorption of gaseous substances by means of known processes.

All the fibers comprised in this embodiment of the invention, as well as the fibers comprised in the other embodiments described hereinafter, may have any length and may be obtained in any manner, for example by breaking up filaments as regards the carbon fibers, which obviously, regardless of how they are obtained, are always activated for the adsorption of gaseous substances.

The mat that leads to the formation of the described sheet can be obtained in a conventional apparatus supplied with the cited materials in the required proportions.

A sheet of filtering mass has thus been obtained which is capable of retaining both the particulate fraction, by virtue of the presence of the standard fibers, and, by virtue of the presence of the carbon fibers, the undesirable gaseous substances contained in the air that crosses it in a direction that can be the one indicated by the arrows in the figure but can also be the opposite direction.

Further embodiments of the invention are now described, always adopting the graphical representation in which the standard fibers 2 are shown in thin lines and the carbon fibers 3 are shown in thick lines.

The sheet 4 of FIG. 2 comprises two layers, i.e., a layer 4a comprising pure standard fibers 2 and a layer 4b comprising pure carbon fibers 3.

The sheet 5 of FIG. 3 also comprises two layers 5a, 5b, both comprising standard fibers 2 and carbon fibers 3.

The sheet 6 of FIG. 4 comprises two layers: a layer 6a, which comprises pure standard fibers 2, and a layer 6b, which comprises standard fibers 2 and carbon fibers 3.

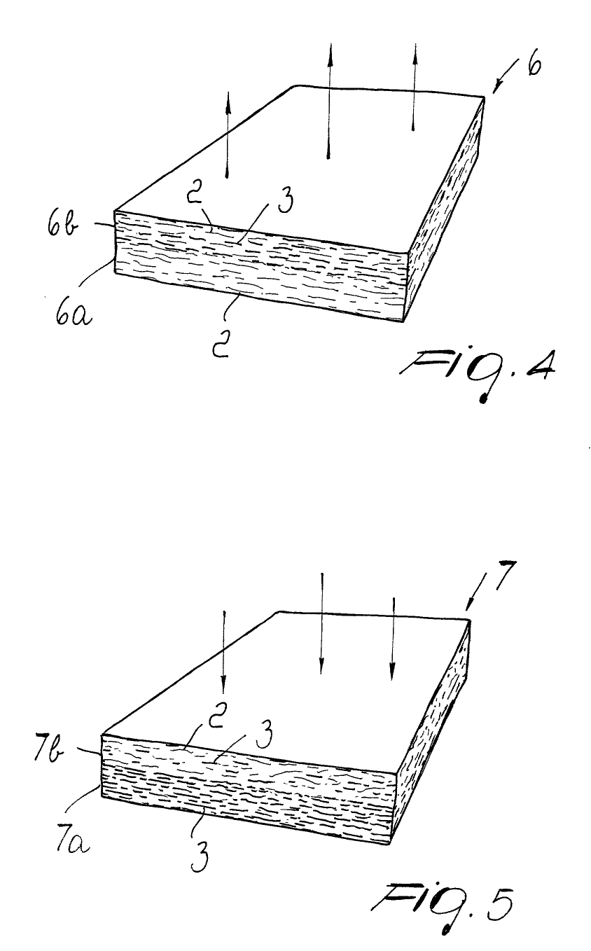

Finally, the sheet 7 of FIG. 5 comprises two layers 7a and 7b: the first one comprises pure carbon fibers 3 and the second one comprises standard fibers 2 and carbon fibers 3.

All these sheets are arranged in the filter so that the first layer crossed by the air is the one that comprises standard fibers, as shown by the arrows in the figures.

A method for obtaining a sheet of filtering mass of the type described with reference to FIGS. 2 to 5 comprises a first step, for obtaining in output from an appropriately supplied apparatus a mat suitable to form the first layer of the sheet, and a second step, for depositing on said mat, in the presence of adhesive or not, loose fibers suitable to form the second layer; this is followed by the impregnation and finishing steps.

Another method for obtaining a sheet of the type shown in FIGS. 2 to 5 comprises a first step, in which two mats are formed in a superimposed configuration by two different appropriately supplied apparatuses, such mats being meant to form respectively the first and second layers of the sheet, and subsequent impregnation and finishing steps.

Another method for obtaining a sheet of filtering mass with two layers provides for the formation of two perfectly finished separate mats, suitable to form respectively the first and second layers of the sheet, and the gluing thereof in a superimposed configuration.

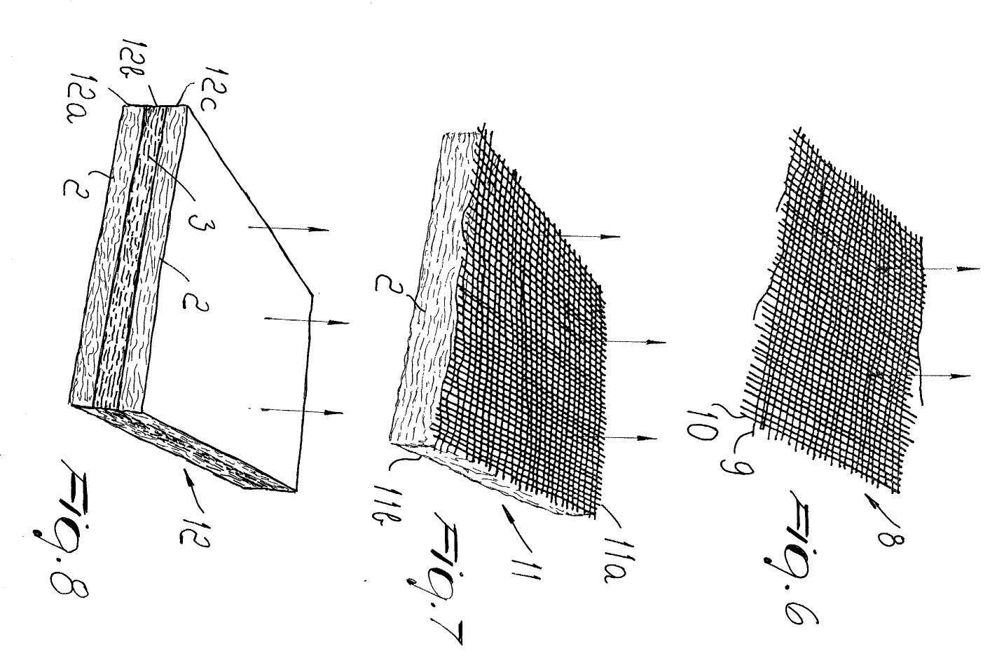

FIG. 6 illustrates another variation 8 of the invention, which comprises a single layer formed bv elements in filament form made of standard-tvpe materials such as 9 and of carbon filaments such as 10, woven so as to form an actual fabric.

Obviously, the carbon filaments such as 10 are activated, and so are the carbon fibers considered earlier, for the adsorption of gaseous substances.

In the variation 11 of FIG. 7 there is a first layer 11a of fabric, exactly of the type shown in FIG. 6, and a second layer 11b comprising pure standard fibers.

Further variations can be provided by combining a layer of actual fabric, such as 8 of FIG. 6 or 11a of FIG. 7, with a layer that comprises pure carbon fibers, or with a layer comprising mixed standard fibers and carbon fibers.

All the above described embodiments can be provided with an additional supporting layer, normally arranged on the air exit side, as in the case for example of the sheet 12 of FIG. 8, which is obtained by adding to a sheet with two layers 12a and 12b, such as the one shown in FIG. 2, a third layer 12c made of standard fibers 2.

A sheet such as the one described above can be obtained with a method that provides for a first step for forming three superimposed mats produced by different apparatuses suitable to form respectively the three layers, and final steps for impregnation and finishing, or also with a method that provides for a step for gluing two finished mats made of standard fibers, after inserting carbon fibers between them in any manner.

In a different embodiment, the supporting layer can be provided by means of a net.

The invention is susceptible of numerous other modifications and variations, all of which are within the scope of the inventive concept.

What is claimed is:

1. A filtering mass in sheet form for an air filter for an enclosed space, particularly a motor vehicle cabin, comprising elements made of standardtype materials normally used to form filtering masses and carbon elements rendered active for the adsorption of gaseous substances.

2. The filtering mass according to claim 1, comprising a single layer comprising said elements in the form of standard fibers and carbon fibers.

3. The filtering mass according to claim 1, comprising two layers that comprise respectively pure standard fibers and said pure carbon fibers.

4. The filtering mass according to claim 1, comprising two layers, both of which comprise said standard fibers and carbon fibers.

5. The filtering mass according to claim 1, comprising two layers that respectively comprise said standard fibers with carbon fibers and pure standard fibers.

6. The filtering mass according to claim 1, comprising two layers that comprise respectively standard fibers with carbon fibers and pure carbon fibers.

7. The filtering mass according to claim 1, comprising at least one layer which comprises elements in filament form made of standard-type materials and carbon filaments, woven so as to form an actual fabric.

8. The filtering mass according to claim 1, comprising a single layer comprising elements in filament form made of standard-type materials and carbon filaments, woven so as to form an actual fabric.

9. The filtering mass according to claim 1, comprising a layer comprising elements in filament form made of standard-type materials and carbon filaments, woven so as to form an actual fabric, and a layer comprising pure standard fibers.

10. The filtering mass according to claim 1, comprising a layer comprising elements in filament form made of standard-type materials and carbon filaments, woven so as to form an actual fabric, and a layer comprising pure carbon fibers.

11. The filtering mass according to claim 1, comprising a layer comprising elements in filament form made of standard-type materials and of carbon filaments, woven so as to form an actual fabric, and a layer comprising standard fibers and carbon fibers.

12. The filtering mass according to claim 1, comprising an additional supporting layer.

13. The filtering mass according to claim 12, wherein the supporting layer is provided by means of standard fibers.

14. The filtering mass according to claim 12, wherein the supporting layer is provided by means of a net.

15. A method for obtaining a filtering mass with at least two layers, comprising a first step for obtaining at least one mat in output from an apparatus which is suitable to form a first layer, a second step for depositing on said mat loose fibers suitable to form a second layer, and final steps for impregnation and finishing.

16. The method for obtaining a filtering mass with at least two layers according to claim 15, wherein two superimposed mats are produced by different apparatuses adapted to form respectively said first and second layers.

17. The method for obtaining a filtering mass with at least two layers according to claim 16, further comprising a step for gluing said superimposed mats which are suitable to form respectively the first layer and the second layer.

18. The method for obtaining a filtering mass with at least two layers of elements in fiber form according to claim 15, wherein said first step forms three superimposed mats produced by different apparatuses, which are suitable to form respectively three layers.

19. The method for obtaining a filtering mass with at least two layers of elements in fiber form according to claim 16, comprising a step for gluing said two mats made of standard fibers after inserting carbon fibers between them.
